(19) United States
(12) Patent Application Publication
(10) Pub. No.: US 2014/0248912 A1
(43) Pub. Date: Sep. 4, 2014

(54) SYSTEMS AND METHODS FOR SHARING OF GEO-TAGGED FILE SEGMENTS BASED ON LOCATION OF A MOBILE DEVICE

(71) Applicant: Barracuda Networks, Inc., Campbell, CA (US)

(72) Inventor: Lindsay Snider, Ann Arbor, MI (US)

(73) Assignee: Barracuda Networks, Inc., Campbell, CA (US)

(21) Appl. No.: 14/193,862

(22) Filed: Feb. 28, 2014

Related U.S. Application Data
(60) Provisional application No. 61/771,792, filed on Mar. 1, 2013.

(51) Int. Cl. H04W 4/02

(52) U.S. Cl. CPC H04W 4/021
USPC 455/456.3

(57) ABSTRACT

A new approach is proposed that contemplates systems and methods to support providing a mobile device associated with a user a plurality of file segments retrieved based on the location of the mobile device. Under the approach, when the user arrives at a location, a remote file/copy server receives a location indicia of the mobile device independent of and separated from a request for an electronic document by the mobile device. The remote server determines a geo-fenced area based on the location indicia of the mobile device, searches for and retrieves from a database one or more geo-tagged file segments that match the location of the mobile device. The remote copy server then assembles a specific edition of the electronic document, which includes at least one geo-tagged file segment pertinent to the location of the mobile device and transmits the assembled electronic document to this and/or another computing/communication device associated with the user and/or another entity at the current/last known location of the user.

### CROSS-REFERENCE TO RELATED APPLICATIONS

This application claims the benefit of U.S. Provisional Patent Application No. 61/771,792, filed Mar. 1, 2013, and entitled “Geo-sharing a plurality of geo-tagged file segments from a store apparatus for assembly in a mobile device at a location,” and is hereby incorporated herein by reference.

### BACKGROUND

A geo-fence is a virtual perimeter for a real-world geographic area (referred to hereinafter as a geo-fenced area) at a given location. The geo-fence can either be dynamically generated, for a non-limiting example, as a radius around a business location, or be a predefined set of boundaries, such as school attendance zones or neighborhood boundaries. When a user of a location-based service (LBS) on a location-aware device, such as a Global Positioning Service (GPS) enabled mobile device, enters or exits a geo-fenced area, the device generated a notification containing information about the location of the device. The notification may then be transmitted by the device to a remote computer/server for further processing.

A cloud-based file storage or file copy service enables a user/client to store, protect, and share his/her files/documents via one or more file storage or copy servers over a network. The copy servers deduplicate, store, manage, and provision the files with security features and protection measures, where the files may be shared among a plurality of users having various access authorizations to the files either publicly or privately. Each of the files/documents may include a plurality of file segments, and each file segment may be included as a part of different versions of the same file or among different files on the same/relevant subject. The cloud-based file storage service also enables the user to access and synchronize the files stored in the file storage servers to and from anywhere via applications or apps running on various computing platforms/appliances including but not limited to desktop systems and mobile computing/communication devices.

When the cloud-based file storage service shares a file with a user, it needs to ensure that the content of the file being shared is pertinent to the user who receives it. If the file has little information of use to the user or the information desired by the user is buried among other unrelated information the user is not interested in at least at the present time, the file may be considered as a spam by the user.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 shows an example of a system diagram to support sharing of geo-tagged file segments based on location of a mobile device.

FIG. 2 depicts an example of a set of file segments stored in a geo-tagged file database.

FIG. 3 depicts a flowchart of an example of a process to support sharing of geo-tagged file segments based on location of a mobile device.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support providing a mobile device associated with a user a plurality of file segments retrieved based on the location of the mobile device. Under the approach, when the user arrives at a location, a remote file/copy server receives a location indicia of the mobile device independent of and separated from a request for an electronic document by the mobile device. The remote copy server determines a geo-fenced area based on the location indicia of the mobile device, searches for and retrieves from a geo-tagged file database one or more geo-tagged file segments that match the location of the mobile device. The remote copy server then assembles a specific edition of the electronic document, which includes at least one geo-tagged file segment pertinent to the location of the mobile device and transmits the assembled electronic document to this and/or another computing/communication device associated with the user and/or another entity at the current/last known location of the user.

By providing the user of the mobile device with an edition of an electronic document that includes at least one file segment pertinent to his/her current location, the proposed approach avoids unnecessary duplication and distribution of files that are of no use to the user at the current location. The user-specific edition of the electronic document is generated for the user either upon receiving a document request from the user or automatically by the file/copy server without requiring an identification (ID) and/or version of the document from the user. In some embodiments, the same or a different user may receive a different edition of the document having the same/similar subject matter but customized based on the current/last known location of the same or different user when the same or different user enters a different geo-fenced area. In some embodiments, the specific edition of the document can be transmitted to an electronic device associated with another person or entity within the same geo-fenced area of the user in addition to or as an alternative to transmitting the document to one or more of the computing/communication devices of the user.

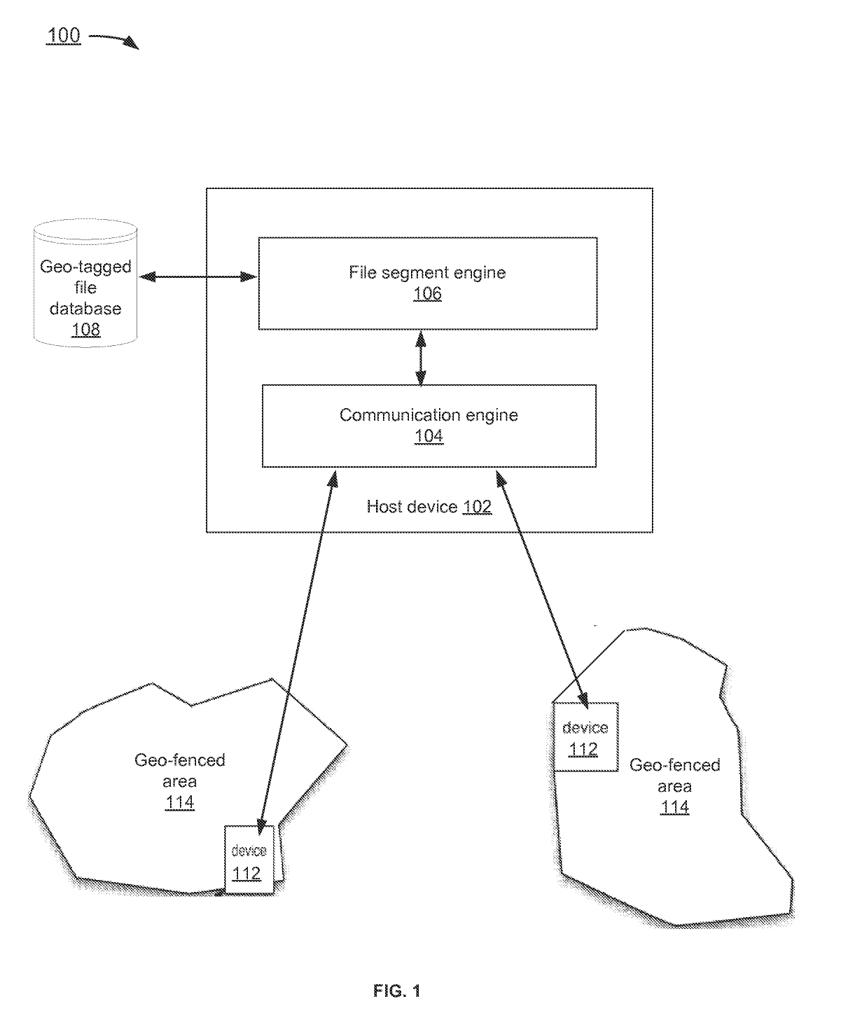

FIG. 1 shows an example of a diagram of system 100 to support sharing of geo-tagged file segments based on location of a mobile device. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes at least communication engine 104, file segment engine 106, and geo-tagged file database 108. As used herein, the term engine refers to software, firmware, hardware, or other component that is used to effectuate a purpose. The engine will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, each of the communication engine 104 and file segment engine 106 can run on at least one host device/server (host) 102. Here, host device 102 can be a computing device, a communication device, a storage device, a file/copy server, or any electronic device capable of running a software component. For non-limiting examples, a computing device can be but is not limited to a laptop PC, a desktop PC, a tablet PC, an iPod, an iPhone, an iPad, an Android-based device or a server machine. A storage device can be but is not limited to a hard disk drive, a flash memory drive, or any portable storage device.

In the example of FIG. 1, each of the communication engine 104 and the file segment engine 106 has a communication interface (not shown), which is a software component that enables the engines to communicate with each other and mobile device 112 over a network (not shown) following certain communication protocols, such as TCP/IP protocol. Here, the network can be a communication network based on certain communication protocols, such as TCP/IP protocol. Such network can be but is not limited to, internet, intranet, wide area network (WAN), local area network (LAN), wireless network, Bluetooth, WiFi, mobile communication network, or any other network type. The physical connections of the network and the communication protocols are well known to those of skill in the art.

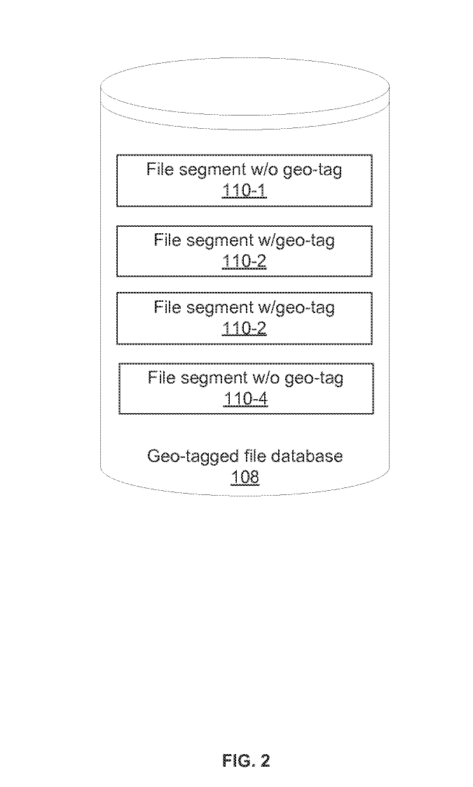

In the example of FIG. 1, the geo-tagged file database 108 is communicatively coupled to the host device 102. As used herein, the term database is used broadly to include any known or convenient means for storing data, whether centralized or distributed, relational or otherwise. The geo-tagged file database 108 stores and maintains a plurality of file segments, wherein at least some of the plurality of file segments are geo-tagged. FIG. 2 depicts an example of a set of file segments 110 stored in the geo-tagged file database 108. As shown in FIG. 2, some of the file segments 110 (e.g., 110-2 and 110-3) are geo-tagged to specific geographical locations, while other file segments 110 (e.g., 110-1 and 110-4) are of general interest and are not tied to any specific geographic locations (may still be tagged with other identifications or classifications discussed below).

In some embodiments, each of the file segments in the geo-tagged file database 108 can be but is not limited to a (plain, rich, or HTML) text, an email, a message, a web-based content, a QR code, a partial file, an image, an audio clip, and an video clip. In some embodiments, the geo-tagged file database 108 may include both file segments with geo-tags as well as file segments without geo-tags. Each of the geo-tagged file segments includes a geo-tag in the form of geographical identification or geospatial metadata. In some embodiments, the geo-tag includes latitude and longitude coordinates or any other geographic information of the location. In some embodiments, the geo-tag may further include one or more of altitude, bearing, distance, accuracy data, name, and nearby businesses or entities at the location. In some embodiments, each of the file segments without a geo-tag may include one or more non-geo-tags or classifications, which can be used for categorizing of the file segments. For non-limiting examples, such non-geo-tags or classifications can be name, identification of a user and/or his/her mobile device, and name and/or type of a business entity or facility.

In the example of FIG. 1, a mobile device 112 associated with a user entering a geo-fenced area 114 around a location is enabled to provide a location-based service (LBS), such as GPS, to generate an indicia of the its current location and to provide such location indicia to the communication engine 104 on host device 102 either voluntarily or upon request by the communication engine 104. In some embodiments, the mobile device 112 is also configured to communicate with the communication engine 104 on host device 102 to request and/or receive an electronic document from the communication engine 104 on host device 102.

In the example of FIG. 1, the communication engine 104 receives from the mobile device 112 the indicia of its current location via a transceiver (not shown). For a non-limiting examples, the indicia can be but is not limited to the latitude and longitude coordinates as well as other geographical identification data indicative of the location of the mobile device 112. In some embodiments, the communication engine 104 receives the indicia of the location voluntarily provided by the mobile device 112 when the user associated with the mobile device 112 arrives at the location. In some embodiments, the communication engine 104 polls the mobile device 112 on a regular basis to request and retrieve the indicia of its current location. Upon receiving the indicia of the current location of the mobile device 112, the communication engine 104 passes the information to the file segment engine 106 for further processing. In some embodiments, the communication engine 104 also receives a request for an electronic document from the mobile device 112, wherein such request may include classification or identification of the type of the document requested.

In the example of FIG. 1, the file segment engine 106 first determines a geo-fenced area 114 around the current location of the mobile device 112 based on the location indicia received. Here, the geo-fenced area 114 can be an area surrounded a predefined set of boundaries around a point of interest, wherein the point of interest can be but is not limited to a public or private facility that allows the user of the mobile device 112 to enter, such as a building, a park, a school campus, a business, a shop, a restaurant, an airport, a train station, etc. In some embodiments, the file segment engine 106 is further configured to identify additional non-geo information about the facility the user of the mobile device 112 may be entering within the identified geo-fenced area 114. For non-limiting examples, such facility information may include name, type, introduction of the facility, and/or instructions to access/use the facility. In some embodiments, the facility information may be associated and maintained with the geo-fenced area 114 in the form of metadata.

Once the geo-fenced area 114 of the mobile device 112 has been determined, the file segment engine 106 searches the geo-tagged file database 108 for retrieve geo-tagged file segments which geo-tags match the geo-fenced area 114 of the mobile device 112. In some embodiments, the file segment engine 106 is configured to also search the geo-tagged file database 108 for one or more non-geo-tagged file segments which tags and/or classifications match the non-geo information identified in the geo-fenced area 114. The geo-tagged file database 108 includes file segments 110 with either geo-tags or non-geo-tags or both as described above. Here, the non-geo information includes but is not limited to, identification of the user and/or his/her associated mobile device 112, and/or the name/type of the facility the user is entering.

In some embodiments, the file segment engine 106 assembles the plurality of file segments 110 retrieved from the geo-tagged file database 108 into an edition of an electronic document, wherein at least one of the file segments 110 in the edition of the document is geo-tagged to the geo-fenced area 114 pertinent to the location of the mobile device 112. The order/sequence by which the file segments are assembled depends on the type of the electronic document being assembled. Once assembled, the file segment engine 106 provides the edition of the electronic document to the communication engine 104, which then transmits it to the mobile device 112 associated with the user. In some embodiments, in addition to or as an alternative to transmitting the document to the mobile device 112 associated with the user, the communication engine 104 is configured to transmit the edition of the document to another electronic device associated with the user. For a non-limiting example, once a user's the location is determined based on the location indicia of his/her cell phone, the geo-tagged document may be transmitted to the user's laptop, which may also be with the user but may not have its LBS enabled. In some embodiments, in addition to or as an alternative to transmitting the document to the mobile device 112 associated with the user, the communication engine 104 is configured to transmit the edition of the document to an electronic device associated with another entity other than the user within the same geo-fenced area 114. For a non-limiting example, the another entity can be a facility and/or a business the user is entering within the geo-fenced area 114. In some embodiments, the communication engine 104 is configured to transmit the plurality of file segments 110 retrieved from the geo-tagged file database 108 to the mobile device 112 associated with the user unassembled, which enables the user to assemble the document from the plurality of file segments 110 in a format of his/her choice. In some embodiments, the communication engine 104 is configured to transmit a “partial file” as a file segment to the mobile device 112, wherein transmitting the partial file alone is sufficient to reconstruct the geo-fenced view of the document for the location. For a non-limiting example, if a business entity has a contract that has a different signature page depending on what state the user lives in, only the signature page of the document needs to be transmitted to the user when the user moves from one state to another. In some embodiments, instead of transmitting the file segments and/or the document to the mobile device, the communication engine 104 is configured to make the edition of the document available for retrieval or download to the mobile device associated with the user upon request.

The following is a non-limiting example to illustrate the operation of the system 100 to support sharing of geo-tagged file segments based on the location of a mobile device of a user. When the user arrives at an airport (e.g., SFO), an indicia of his/her current location is provided by or polled from a mobile device 112 associated with the user to the communication engine 104 on a remote host device. The file segment engine 106 determines that the user has entered the geo-fenced area of SFO based on indicia of his/her current location, and searches the geo-tagged file database 108 for file segments that are geo-tagged for SFO as well as file segments that are tagged the user/mobile device identification and/or air travel in general. For a non-limiting example, such file segments may include non-geo-tagged file segment(s) on general air travel and safety information, file segment(s) geo-tagged for SFO-specific information such as an introduction of SFO terminals, and file segment(s) tagged for gate assignment and flight information specific to the user such as a boarding pass. The file segment engine 106 then assembles the file segments together as a single document and provides it to the mobile device 112 of the user via communication engine 104. If the user changes his/her travel plan and goes to a different airport (e.g., SJC) instead, the file segment engine 106 is able to search for file segments specific to SJC once the user enters the geo-fenced area of SJC and to provide the user with a SJC-specific travel document.

For other non-limiting examples, the system 100 is able to provide a user with one or more of conference agendas and meeting rooms locations when the user arrive at a conference hall, check-in and hotel information when the user enters a hotel lobby, restaurant menus when the user enters a restaurant, transportation schedules when the user arrives at a transit station, and current activities and events when the user arrives at a tourist attraction. For other non-limiting examples, the system 100 is able to provide a hotel staff with the check-in information of the user when he/she arrives at the hotel, and to provide a restaurant/coffee shop owner of specific preferences of the user when the user arrives at the restaurant/coffee shop he/she visited frequently.

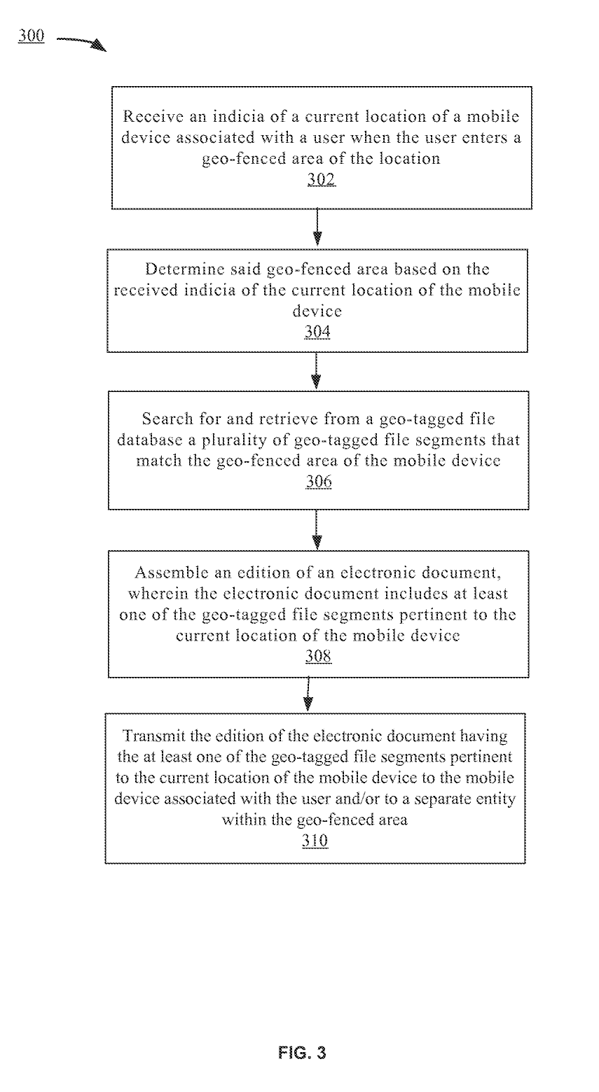

FIG. 3 depicts a flowchart of an example of a process to support sharing of geo-tagged file segments based on location of a mobile device. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 3, the flowchart 300 starts at block 302, where an indicia of a current location of a mobile device associated with a user is received when the user enters a geo-fenced area of the location. The flowchart 300 continues to block 304, where said geo-fenced area is determined based on the received indicia of the current location of the mobile device. The flowchart 300 continues to block 306, where a plurality of geo-tagged file segments that match the geo-fenced area of the mobile device are searched for and retrieved from a geo-tagged file database. The flowchart 300 continues to block 308, where an edition of an electronic document is assembled, wherein the electronic document includes at least one of the geo-tagged file segments pertinent to the current location of the mobile device. The flowchart 300 end at block 310 where the edition of the electronic document having the at least one of the geo-tagged file segments pertinent to the current location of the mobile device is transmitted to the mobile device associated with the user and/or to a separate entity within the same geo-fenced area.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

The methods and system described herein may be at least partially embodied in the form of computer-implemented processes and apparatus for practicing those processes. The disclosed methods may also be at least partially embodied in the form of tangible, non-transitory machine readable storage media encoded with computer program code. The media may include, for example, RAMs, ROMs, CD-ROMs, DVD-ROMs, BD-ROMs, hard disk drives, flash memories, or any other non-transitory machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, the computer becomes a special purpose computer for practicing the methods. When implemented on a general-purpose processor, the computer program code segments configure the processor to create specific logic circuits. The methods may alternatively be at least partially embodied in a digital signal processor formed of application specific integrated circuits for performing the methods.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and with various modifications that are suited to the particular use contemplated.

What is claimed is:

1. A system, comprising:
a file segment engine running on a host, which in operation, is configured to
determine a geo-fenced area based on an indicia of a current location of a mobile device associated with a user;
search and retrieve from a geo-tagged file database one or more geo-tagged file segments that match the geo-fenced area of the mobile device;
assemble an edition of an electronic document, wherein the electronic document includes at least one of the geo-tagged file segments pertinent to the current location of the mobile device;
a communication engine running on a host, which in operation, is configured to
accept said indicia of the current location of the mobile device associated with the user when the user enters a geo-fenced area of the location;
transmit the edition of the electronic document having the at least one of the geo-tagged file segments pertinent to the current location of the mobile device to the mobile device associated with the user and/or to a separate entity within the geo-fenced area.

2. The system of claim 1, wherein:
each of the file segments is one of a text, an email, a message, a web-based content, a QR code, a partial file, an image, an audio clip, and an video clip.

3. The system of claim 1, wherein:
the geo-tagged file database is configured to store and maintain a plurality of file segments, wherein at least one or more of the plurality of file segments are tagged with geo-tags.

4. The system of claim 3, wherein:
each of the geo-tags includes latitude and longitude coordinates or other geographic information of the location.

5. The system of claim 3, wherein:
each of the geo-tags includes one or more of altitude, bearing, distance, accuracy data, name, and nearby businesses or entities at the location.

6. The system of claim 3, wherein:
each of the file segments without a geo-tag includes one or more non-geo-tags or classifications for categorizing of the file segments.

7. The system of claim 1, wherein:
the indicia of the current location of the mobile device is voluntarily provided by the mobile device when the user associated with the mobile device arrives at the location.

8. The system of claim 1, wherein:
the communication engine is configured to request the indicia of the current location of the mobile device from the mobile device.

9. The system of claim 1, wherein:
the communication engine is configured to receive a request for the electronic document from the mobile device, wherein such request includes classification or identification of the type of the document requested.

10. The system of claim 1, wherein:
the geo-fenced area is an area surrounded a predefined set of boundaries around a point of interest, wherein the point of interest is a public or private facility that allows the user of the mobile device to enter.

11. The system of claim 10, wherein:
the file segment engine is configured to identify additional non-geo information about the facility the user of the mobile device is entering within the geo-fenced area.

12. The system of claim 11, wherein:
the file segment engine is configured to search the geo-tagged file database for one or more non-geo-tagged file segments which non-geo-tags match the non-geo information identified in the geo-fenced area.

13. The system of claim 11, wherein:
the file segment engine is configured to transmit the edition of the document to another electronic device associated with the user, in addition to or as an alternative to transmitting the document to the mobile device associated with the user.

14. The system of claim 1, wherein:
the communication engine is configured to transmit the edition of the document to an electronic device associated with another entity other than the user within the same geo-fenced area, in addition to or as an alternative to transmitting the document to the mobile device associated with the user.

15. The system of claim 1, wherein:
the communication engine is configured to make the edition of the document available for retrieval or download to the mobile device associated with the user upon request.

16. The system of claim 1, wherein:
the communication engine is configured to transmit the plurality of file segments retrieved from the geo-tagged file database to the mobile device associated with the user unassembled, thereby enabling the user to assemble the document from the plurality of file segments in a format of his/her choice.

17. A computer-implemented method, comprising:
accepting an indicia of a current location of a mobile device associated with a user when the user enters a geo-fenced area of the location;
determining said geo-fenced area based on the received indicia of the current location of the mobile device;
searching for and retrieving from a geo-tagged file database a plurality of geo-tagged file segments that match the geo-fenced area of the mobile device;
assembling an edition of an electronic document, wherein the electronic document includes at least one of the geo-tagged file segments pertinent to the current location of the mobile device;
transmitting the edition of the electronic document having the at least one of the geo-tagged file segments pertinent to the current location of the mobile device to the mobile device associated with the user and/or to a separate entity within the geo-fenced area.

18. The method of claim 17, further comprising:
storing and maintaining a plurality of file segments in the geo-tagged file database, wherein at least one or more of the plurality of file segments are tagged with geo-tags.

19. The method of claim 17, further comprising:
providing the indicia of the current location of the mobile device by the mobile device when the user associated with the mobile device arrives at the location.

20. The method of claim 17, further comprising:
requesting the indicia of the current location of the mobile device from the mobile device.

21. The method of claim 17, further comprising:
receiving a request for the electronic document from the mobile device, wherein such request includes classification or identification of the type of the document requested.

22. The method of claim 17, further comprising:
identifying additional non-geo information about a facility the user of the mobile device is entering within the geo-fenced area.

23. The method of claim 22, further comprising:
searching the geo-tagged file database for one or more non-geo-tagged file segments which non-geo-tags match the non-geo information identified in the geo-fenced area.

24. The system of claim 17, further comprising:
transmitting the edition of the document to another electronic device associated with the user, in addition to or as an alternative to transmitting the document to the mobile device associated with the user.

25. The method of claim 17, further comprising:
transmitting the edition of the document to an electronic device associated with another entity other than the user within the same geo-fenced area, in addition to or as an alternative to transmitting the document to the mobile device associated with the user.

26. The method of claim 17, further comprising:
making the edition of the document available for retrieval or download to the mobile device associated with the user upon request.

27. The method of claim 17, further comprising:
transmitting the plurality of file segments retrieved from the geo-tagged file database to the mobile device associated with the user unassembled, thereby enabling the user to assemble the document from the plurality of file segments in a format of his/her choice.

28. A non-transitory computer readable medium having software instructions stored thereon that when executed cause a system to:
accept an indicia of a current location of a mobile device associated with a user when the user enters a geo-fenced area of the location;
determine said geo-fenced area based on the received indicia of the current location of the mobile device;
search for and retrieve from a geo-tagged file database a plurality of geo-tagged file segments that match the geo-fenced area of the mobile device;
assemble an edition of an electronic document, wherein the electronic document includes at least one of the geo-tagged file segments pertinent to the current location of the mobile device;
transmit the edition of the electronic document having the at least one of the geo-tagged file segments pertinent to the current location of the mobile device to the mobile device associated with the user and/or to a separate entity within the geo-fenced area.
